(19) United States
(12) Patent Application Publication
(10) Pub. No.: US 2012/0112103 A1
(43) Pub. Date: May 10, 2012

(54) SEAL ASSEMBLY FOR METERING VALVE

(75) Inventor: Sandeep Krishnan, San Diego, CA (US)

(73) Assignee: HAMILTON SUNDSTRAND CORPORATION, Windsor Locks, CT (US)

(21) Appl. No.: 12/942,406

(22) Filed: Nov. 9, 2010

(51) Int. Cl. F16K 31/02; F16J 15/06; H02K 5/10

(52) U.S. Cl. 251/129.01; 310/71; 277/641

(57) ABSTRACT

A seal assembly for an electric component includes a generally cylindrical plug, a first O-ring seal and a second O-ring seal. The plug includes a sidewall extending between first and second end walls. An annular groove circumscribes the sidewall. A first O-ring seal is disposed in the annular groove. A first through-bore extends between the first end wall and the second end wall. A first counter-bore circumscribes the first through-bore in the first end wall. A second O-ring seal is disposed within the first counter-bore.

### BACKGROUND

The present invention relates generally to metering valves. More particularly, the present invention is directed to sealing arrangements in electrically actuated metering valves.

Typical metering valves used in gas turbine engines are electromagnetically actuated. For example, some valves use a solenoid actuator to linearly displace a tube through which fuel or some other liquid flows to the gas turbine engine. The position of the tube relative to a contoured stop determines the flow rate of fuel through the valve. Actuation of the tube is controlled by electronics that operates the solenoid actuator in response to fuel demand signals generated by an engine controller.

Metering valves are often used in conjunction with gas turbine engines used in industrial applications, such as for power generation. These gas turbine engines are often used in natural gas pipeline operations where natural gas is used as fuel for the turbine. Fuel is delivered to the engine through a metering valve that precisely delivers quantities of the fuel to a combustor as the engine needs the fuel. A common problem with fuel metering valves in these applications relates to leakage of natural gas, or some other fuel, through the valve housing and into the valve electronics. Particularly, fuel may leak into the fuel metering valve where electrical wires pass through valve housing. Contact of gas or fuel with the electronics degrades the working life of such components. Various attempts have been made to seal leak paths in the valve housing, such as by applying a potting compound or caulk where wires pass through the housing. These seals are, however, soft and lose effectiveness at high pressures.

### SUMMARY

A seal assembly for an electric component comprises a generally cylindrical plug, a first O-ring seal and a second O-ring seal. The plug includes a sidewall extending between first and second end walls. An annular groove circumscribes the sidewall. A first O-ring seal is disposed in the annular groove. A first through-bore extends between the first end wall and the second end wall. A first counter-bore circumscribes the first through-bore in the first end wall. A second O-ring seal is disposed within the first counter-bore.

### BRIEF DESCRIPTION OF THE DRAWINGS

FIG. 1 is a block diagram of a fuel metering system.

FIG. 2 is a perspective view of a fuel metering valve of the fuel metering system.

FIG. 3 is a front cross-sectional view of the fuel metering valve of FIG. 2 showing a solenoid actuator.

FIG. 4 is a perspective view of the solenoid actuator of FIG. 3 showing the location of a seal assembly of the present invention.

FIG. 5 is a front cross-sectional view of the solenoid actuator and seal assembly of FIG. 4 showing motor wiring extending through a seal plug.

FIG. 6 is a close-up view of the seal plug of FIG. 5 showing the location of O-rings within plug grooves.

### DETAILED DESCRIPTION

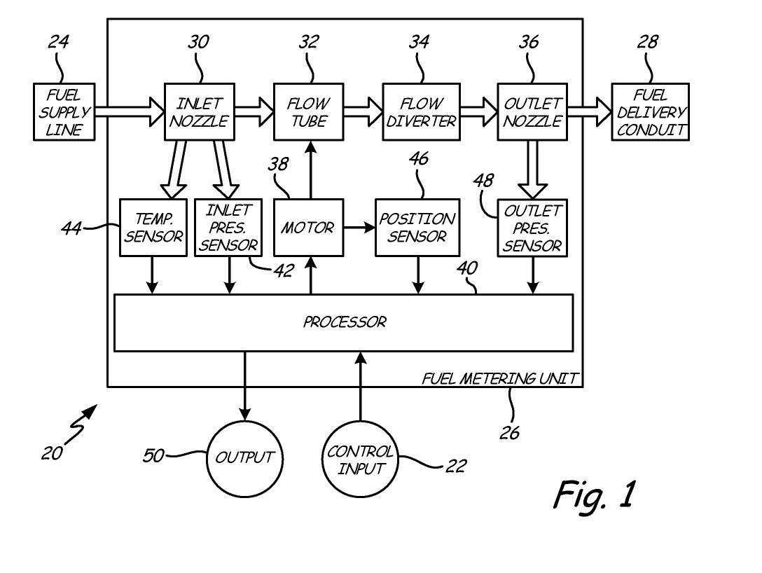

FIG. 1 is a block diagram of fuel metering system 20 suitable for use with a gas turbine engine (not shown). Fuel metering system 20, which receives commands from control input 22, includes fuel supply line 24, fuel metering unit 26 (also referred to as fuel metering valve 26), and fuel delivery conduit 28. Fuel metering unit 26 includes inlet nozzle 30, flow tube 32, flow diverter 34, outlet nozzle 36, motor 38 (i.e., a motor capable of producing linear motion such as a solenoid actuator), processor 40, inlet pressure sensor 42, temperature sensor 44, position sensor 46, and outlet pressure sensor 48. Processor 40 provides a signal to output 50.

During operation, fuel supply line 24 supplies fuel to fuel metering unit 26, which delivers the fuel in a metered and controlled manner out through fuel delivery conduit 28 to a combustor (not shown). Within fuel metering unit 26, the fuel flows through inlet nozzle 30, flow tube 32, and outlet nozzle 36, and then exits fuel metering unit 26.

At inlet nozzle 30, a portion of the fuel is diverted to inlet pressure sensor 42. Inlet pressure sensor 42 senses the fuel pressure at the inlet of fuel metering unit 26 and generates an inlet pressure signal. Temperature sensor 44 senses the fuel temperature at the inlet of fuel metering unit 26 and generates a temperature signal. Both the input pressure signal and the temperature signal are received by processor 40. Inlet pressure sensor 42 and temperature sensor 44 can be of known configurations. Processor 40 can be of a known configuration, such as a microprocessor.

Motor 38 supports and selectively moves flow tube 32 toward and away from flow diverter 34, which is fastened by a threaded fastener to outlet nozzle 36. Position sensor 46 senses a distance between flow tube 32 and flow diverter 34, which is also referred to as the stroke of the motor, and generates a position signal. In operation, a flow rate of the fuel through fuel metering unit 26 can be controlled by selectively positioning flow tube 32 relative to flow diverter 34. For example, a distance of zero would mean that the flow is completely stopped at flow diverter 34. By actuating motor 38 to move flow tube 32 away from flow diverter 34, a gap is formed between flow tube 32 and flow diverter 34 permitting flow.

At outlet nozzle 36, an additional portion of the fuel is diverted to outlet pressure sensor 48. Outlet pressure sensor 48 senses the fuel pressure at the outlet of fuel metering unit 26 and generates an output pressure signal. Both the position signal and the outlet pressure signal are received by processor 40. Position sensor 46 and outlet pressure sensor 48 can each be of any known configuration.

Fuel metering unit 26 can be configured and operated generally similar to that described in U.S. Pat. No. 6,882,924 to Miller, which describes a fuel metering valve and a control system for regulating fuel delivery to a gas turbine engine. However, the configuration of fuel metering unit 26 can vary as desired for particular applications. The present invention provides a seal assembly suitable for use in the aforementioned fuel metering units.

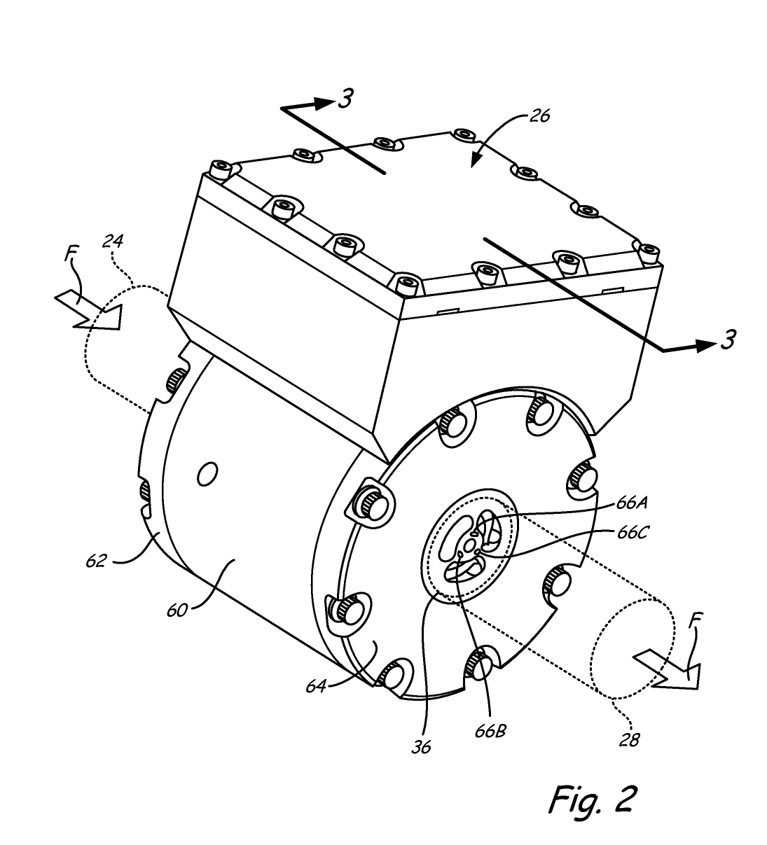

FIG. 2 is a perspective view of fuel metering unit 26, which includes fuel meter housing 60. Fuel metering unit 26, which includes inlet nozzle 30 and outlet nozzle 36, is mated in sealed engagement with fuel supply line 24 (shown in phantom) and fuel delivery conduit 28 (shown in phantom), through which fluid F flows. Inlet nozzle 30 is supported by inlet nozzle support structure 62. Similarly, outlet nozzle 36 is supported by outlet nozzle support structure 64.

Fuel delivery conduit 28 is secured in sealing engagement with outlet nozzle 36. Outlet nozzle 36 can be threaded, for example, into outlet nozzle support structure 64, which can be fastened, in one alternative shown in FIG. 2, to fuel meter housing 60 using bolts. The shape and dimensions of outlet nozzle support structure 64 can vary as desired for particular applications. As shown in FIG. 2, outlet nozzle 36 has outlet pressure taps 66A-66C for each diverting a portion of the fuel to outlet pressure sensor 48.

Similarly, fuel supply line 24 (shown in phantom) is mated in sealed engagement with inlet nozzle 30 (not visible in FIG. 2), which is located on an opposite side of fuel metering unit 26 from outlet nozzle 36. Inlet nozzle 30 can be threaded, for example, into inlet nozzle support structure 62, which can be fastened, as shown in one alternative in FIG. 2, to fuel meter housing 60 using bolts or other suitable fasteners. The shape and dimensions of inlet nozzle support structure 62 can vary as desired for particular applications.

As discussed in greater detail below, fluid F flows through flow tube 32, which is sealed by a dynamic sealing arrangement that permits flow tube 32 to move, while preventing the dry side of the fuel metering unit 26 from becoming wet. However, fluid F may, under certain adverse conditions, leak into the dry side of housing 60. The seal assembly of the present inventions prevents fluid F that has leaked into the dry side from further leaking into electrically active components, such as motor 38.

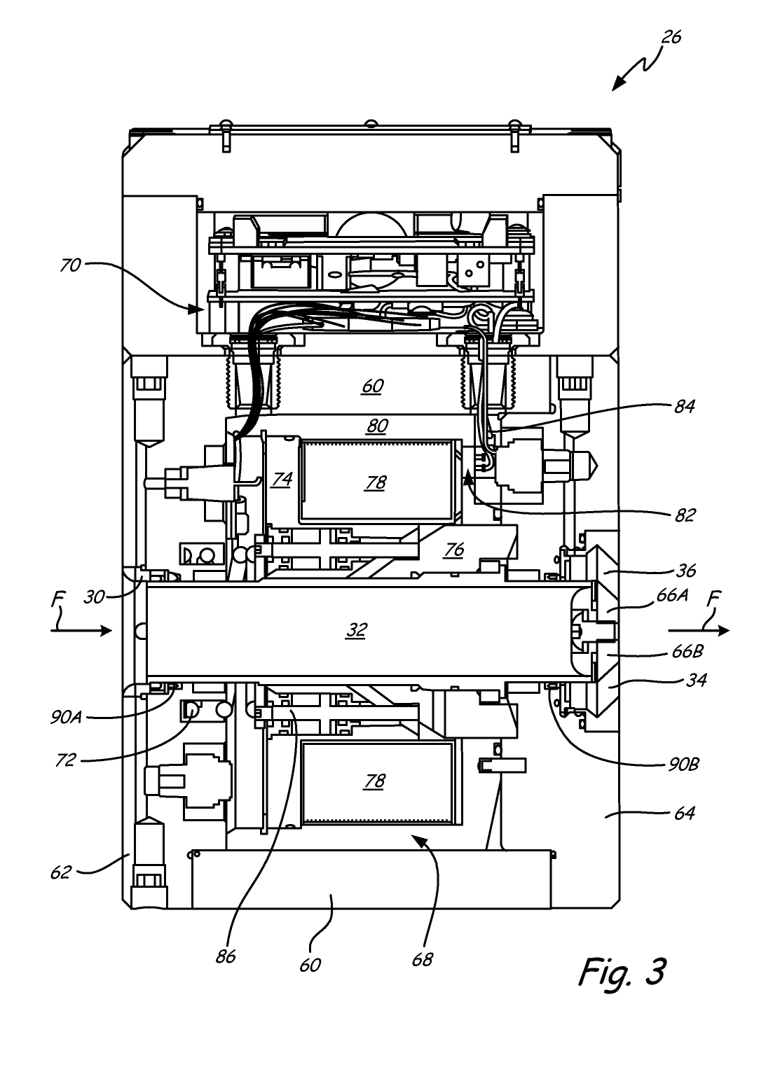

FIG. 3 is a front cross-sectional view of fuel metering unit 26 of FIG. 2 showing solenoid 68. Fuel metering unit 26 includes inlet nozzle 30, flow tube 32, outlet nozzle 36, valve housing 60, inlet nozzle support structure 62, outlet nozzle support structure 64, outlet pressure taps 66A and 66B, solenoid 68, circuitry 70, coil spring 72, pole piece 74, armature 76 and flow diverter 34. Solenoid 68, which comprises an embodiment of motor 38, includes wire windings 78, motor housing 80, seal assembly 82 and motor wiring 84.

As described above, fluid F is introduced into fuel metering unit 26 at inlet nozzle 30 of support structure 62. Solenoid 68 adjusts the position of flow tube 32 to allow fluid F to flow into outlet nozzle 36. Specifically, flow tube 32 is retracted from contact with flow diverter 34 to allow fluid F into pressure taps 66A and 66B of outlet nozzle 36. Circuitry 70 sends activation current to wire windings 78 through motor wiring 84. The activation current generates electro-magnetic flux in wire windings 78. The electro-magnetic flux of wire windings 78 energizes pole piece 74 as a magnet, which generates an electro-magnetic force that attracts armature 76. Armature 76 is threaded, or otherwise mechanically connected, to flow tube 32 such that pressure taps 66A and 66B are opened when armature 76 moves toward pole piece 74. When pole piece 74 is not electro-magnetically activated, coil spring 72 acts on armature 76, through pin 86, to maintain flow tube 32 in sealed contact with flow diverter 34 at outlet nozzle 36.

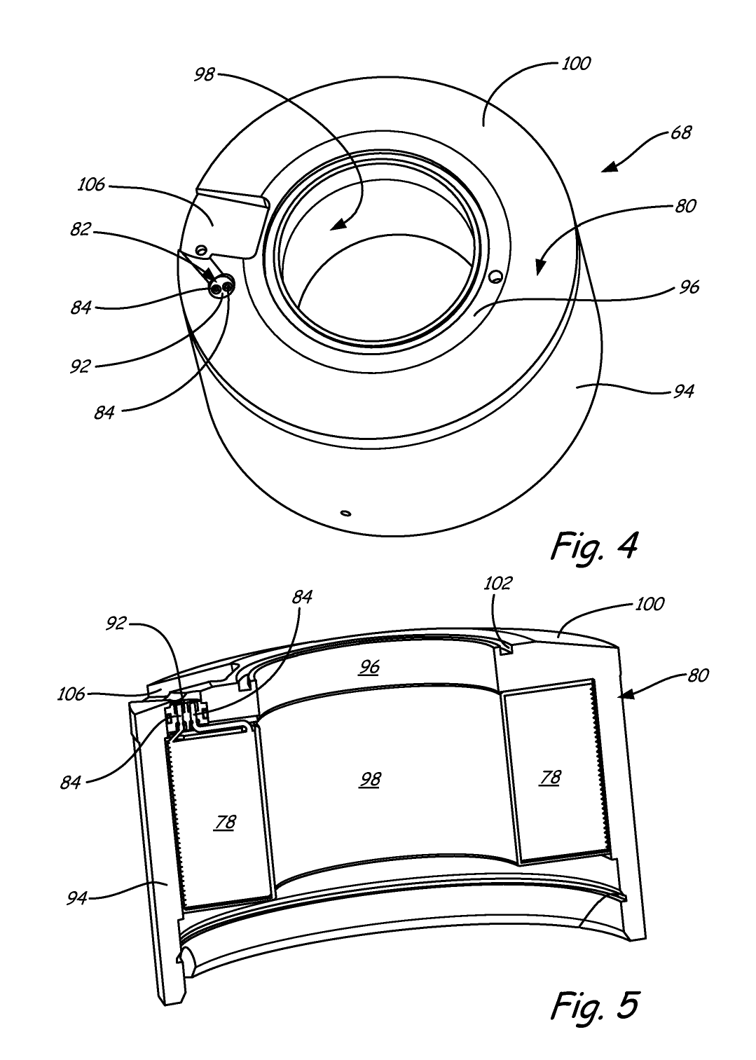

During operation of fuel metering valve 26, fluid F is prevented from entering the interior or “dry side” of fuel metering valve 26, such as to contact solenoid 68, by dynamic seals 90A and 90B, operation of which is generally known in the art. However, the presence of contamination, dirt or debris in fluid F causes wear on seals 90A and 90B, which reduces their effectiveness. In extreme conditions, fluid F may leak into valve housing 60. It is desirable to prevent fluid F from causing damage to fuel metering valve 26 or impairing the operation of fuel metering valve 26 or electronics 70. Fuel metering valve 26 of the present invention is provided with various means for preventing fluid F from entering interior portions of fuel metering valve 26 where the presence of fluid is undesirable, such as electrically active spaces and components. In particular, fuel metering valve 26 is provided with seal assembly 82 to prevent fluid F from entering into solenoid 68. Seal assembly 82 is disposed within motor housing 80 and includes openings to permit motor wiring 84 to enter housing 80 and connect to wire windings 78, as is discussed with reference to FIGS. 4-6.

FIG. 4 is a perspective view of solenoid 68 of FIG. 3 showing the location of seal assembly 82 of the present invention. FIG. 5, which is discussed concurrently with FIG. 4, is a front cross-sectional view of solenoid 68 and seal assembly 82 of FIG. 4 showing motor wiring 84 extending through seal plug 92. Solenoid 68 also includes wire windings 78 and motor housing 80. Housing 80 includes axially extending portion 94, disk portion 96, winding sleeve 98 and wiring surface 100. Winding sleeve 98 comprises a bobbin around which wire windings 78 are wrapped. Winding sleeve 98 is comprises of a non-conducting, dielectric material, such as polyphenylene sulfide (PPS), which is commercially available from Chevron Philips under the trade name Ryton®. Axially extending portion 94 and disk portion 96 are typically comprised of sturdy, corrosion resistant materials that are magnetically conductive, such as 1018 steel.

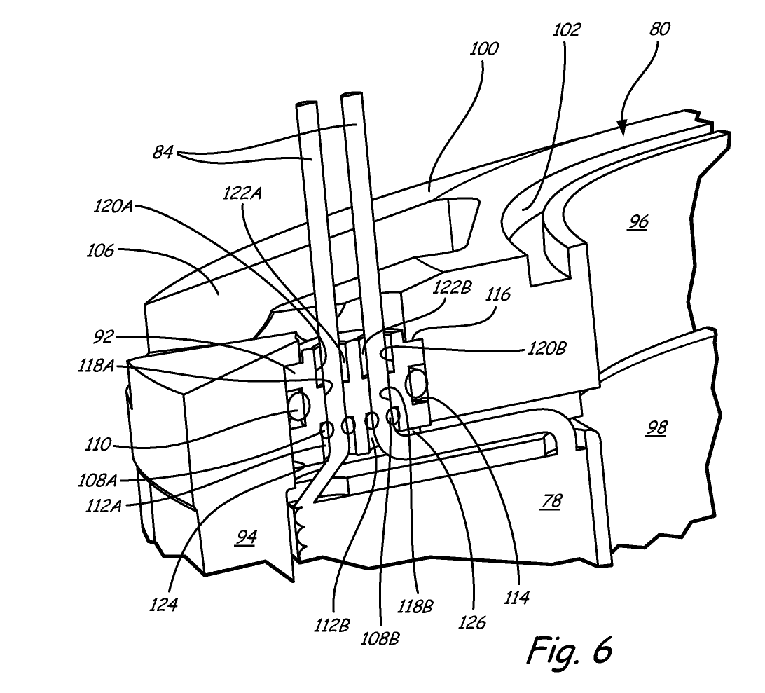

The interior of housing 80 encloses wire windings 78. In particular, winding sleeve 98 adjoins axially extending portion 94 and disk portion 96 to form an enclosure. Winding sleeve 98 is joined to portions 94 and 96 by any suitable means such that wire windings 78 are sealed within motor housing 80. Disk portion 96 includes seal groove 102. O-ring seals, or other such similar seals, are positioned in seal groove 102 to inhibit flow of fluid F that passes through seal 90B from passing through motor housing 80. Likewise, seal assembly 82 prevents fluid F from passing through housing 80 and into the cavity for electronics 70. Wiring surface 100 of disk portion 96 includes cutout 106 to permit motor wiring 84 to be recessed within an exterior surface of motor housing 80. Cutout 106 also includes space to permit a wiring adapter or an electrical component to fit within disk portion 96. Motor wiring 84 is permitted to enter motor housing 80 through seal assembly 82. Seal assembly 82 comprises plug 92 that is disposed within disk portion 96 of motor housing 80 adjacent cutout 106, as is discussed in greater detail with reference to FIG. 6.

FIG. 6 is a close-up view of seal plug 92 of FIG. 5 showing the location of O-rings 108A and 108B and O-ring 110 within plug grooves 112A and 112B and groove 114, respectively. Plug 92 also includes edge notch 116, through-bores 118A and 118B, grooves 120A and 120B and sleeves 122A and 122B. Plug 92 comprises a generally cylindrical body having two end surfaces connected by an annular side wall. Through-bores 118A and 118B extend from a first end wall through to a second end wall. Groove 114 comprises a channel that circumscribes the side wall. Plug 92 is inserted into hole 124 in disk portion 96 of motor housing 80. Hole 124 extends between wiring surface 100 and a back side or interior surface of disk portion 96. O-ring 110 is positioned in groove 114 to seal between plug 92 and disk portion 96. Plug 92 includes edge notch 116, which forms a shoulder that engages a mating surface on disk portion 96 to prevent plug 92 from sliding through hole 124. Plug 92 is comprised of a non-conducting, dielectric material, such as polyphenylene sulfide (PPS), which is commercially available from Chevron Philips under the trade name Ryton®. Plug 92 ensures that wiring 84 does not short to housing 80.

Motor wiring 84 extends through through-bores 118A and 118B from wire windings 78 to connect to circuitry 70 (FIG. 3). Motor wiring 84 comprises a single strand of wiring wound into a coil having two ends that pass through plug 92, a positive wire and a return wire. Through-bores 118A and 118B include grooves 112A and 112B and grooves 120A and 120B to facilitate insertion of wiring 84. Grooves 120A and 120B comprise counter-bores that increase the diameter of through-bores 118A and 118B to accommodate sleeves 122A and 122B, respectively. Sleeves 122A and 122B comprise insulating sleeves that inhibit wiring 84 from engaging edges of body 92 so as to prevent rubbing or kinking. Plug 92 includes notch 126 on an end wall that permits wiring 84 to bend flush with an interior surface of disk portion 96.

Grooves 112A and 112B comprise counter-bores that increase the diameter of through-bores 118A and 118B to accommodate O-rings 108A and 108B, respectively. O-rings 108A and 108B may comprise rubber rings that seal against wiring 84. O-rings 108A and 108B are sized based on the gage size of motor wiring 84. The size of O-rings 108A and 108B is selected to provide at least a minimum squeeze as directed by commonly used O-ring handbooks for static seals. In one non-limiting example, 17 gage AWG copper wires can be paired with an O-ring having MIL spec number M83248/1-001, although other sizes of wires and O-rings can be paired in various combinations in other embodiments.

Additionally, a thin layer of insulation is provided on bare motor wiring 84 to provide further sealing and a redundant layer of electrical insulation. In one embodiment, motor wiring 84 is coated with enamel that provides a smooth surface finish against which O-rings 108A and 108B are better able to seal against, as compared to bare wire. Enamels are also resilient to high temperatures. Vibration of solenoid 68, however, may cause the coating of motor wiring 84 to rub off. As such, thorough-bores 118A and 118B can be provided with sleeves 122A and 122B to reduce friction around motor wiring 84. Coatings are more suitably applied to smooth, single strand, solid wires, rather than multi-stranded, twisted wires.

The present invention provides a seal assembly that permits wiring to pass through electrically active valve, motor, actuator or other similar components, while preventing fluids to leak into the component. The seal assemblies are well suited for use on “dry sides” of such components where fluid in not expected to be encountered. As such, the seal assemblies, as used with reference to the described embodiment, provide backup or secondary seal means. However, in other embodiments, the seal assemblies can be used as primary seals. The sealing assembly of the present invention provides a double O-ring configuration in conjunction with a non-conducting plug. The plug is sealed at its outer diameter by a first, larger O-ring that is recessed into the plug so that plug can be tightly fitted into the electrical component. The plug includes smaller, interior located O-rings to seal directly around wires passing through the plug. Such sealing arrangements of the present invention have been tested to withstand pressures exceeding 500 psi (˜3447.4 kiloPascals). O-rings are more suitably fitted around to smooth, single strand, solid wires, rather than multi-stranded, twisted wires

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A seal assembly for an electric component, the seal assembly comprising:
a generally cylindrical plug having a sidewall extending between first and second end walls;
an annular groove circumscribing the sidewall;
a first O-ring seal disposed in the annular groove;
a first through-bore extending between the first end wall and the second end wall;
a first counter-bore circumscribing the first through-bore in the first end wall; and
a second O-ring seal disposed within the first counter-bore.

2. The seal assembly of claim 1 and further comprising:
a second counter-bore circumscribing the first through-bore in the second end wall; and
a first sleeve disposed within the second counter-bore.

3. The seal assembly of claim 1 and further comprising:
a second through-bore extending between the first end wall and the second end wall;
a third counter-bore circumscribing the second through-bore in the first end wall; and
a third O-ring seal disposed within the third counter-bore.

4. The seal assembly of claim 3 and further comprising:
a fourth counter-bore circumscribing the second through-bore in the second end wall; and
a second sleeve disposed within the fourth counter-bore.

5. The seal assembly of claim 1 wherein the plug is comprised of non-conducting, dielectric material.

6. The seal assembly of claim 1 and further comprising:
an edge notch circumscribing the sidewall at the second end wall to form a shoulder.

7. The seal assembly of claim 1 and further comprising:
an edge notch extending along the first end wall from the first through-bore to the sidewall.

8. The seal assembly of claim 1 and further comprising:
a housing comprising:
an exterior surface including an overhanging flange for engaging the second end wall of the plug;
an interior surface; and
a wiring opening in the housing connecting the exterior surface to the interior surface, wherein the plug is inserted in the wiring opening.

9. The seal assembly of claim 8 wherein the housing further comprises:
a cutout disposed on the exterior surface for flush mounting wiring and circuitry to the housing.

10. The seal assembly of claim 1 and further comprising a wire extending through the first through-bore, the wire including a coating having a smoother surface finish than that of the wire.

11. A motor assembly comprising:
a housing comprising:
a plurality of exterior surfaces;
an interior enclosed by the plurality of exterior surfaces; and
a wiring hole extending through the housing to connect a first exterior surface with the interior;
a magneto-electric drive component disposed inside the interior of the housing;
a seal assembly disposed within the wiring hole, the seal assembly comprising:
a generally cylindrical plug comprising:
first and second end walls;
a sidewall extending between the first and second end walls;
an annular groove circumscribing the sidewall;
a first O-ring seal disposed in the annular groove;
a first through-bore extending between the first end wall and the second end wall;
a first counter-bore circumscribing the first through-bore in the first end wall; and
a second O-ring seal disposed within the first counter-bore; and
a wire extending from the magneto-electric drive component, through the first through-bore and the first exterior wall and out of the housing.

12. The drive assembly of claim 11 and further comprising:
a second counter-bore circumscribing the first through-bore in the second end wall; and
a first sleeve disposed within the second counter-bore.

13. The drive assembly of claim 11 and further comprising:
a second through-bore extending between the first end wall and the second end wall;
a third counter-bore circumscribing the second through-bore in the first end wall; and
a third O-ring seal disposed within the third counter-bore.

14. The drive assembly of claim 13 and further comprising:
a fourth counter-bore circumscribing the second through-bore in the second end wall; and
a second sleeve disposed within the fourth counter-bore.

15. The drive assembly of claim 11 wherein the plug is comprised of non-conducting, dielectric material.

16. The drive assembly of claim 11 and further comprising:
an edge notch circumscribing the sidewall at the second end wall to form a shoulder.

17. The drive assembly of claim 11 and further comprising:
an edge notch extending along the first end wall from the first through-bore to the sidewall.

18. The drive assembly of claim 11 and further comprising:
a cutout disposed on the first exterior surface for flush mounting wiring and circuitry to the motor housing.

19. The drive assembly of claim 11 wherein the wire includes a coating having a smoother surface finish than that of the wire.

20. A fuel metering valve comprising:
a housing including a valve portion and an electronics portion;
an inlet nozzle connected to the valve portion of the housing;
an outlet nozzle connected to the valve portion of the housing, the inlet nozzle including a flow diverter;
a flow tube extending through the valve portion of the housing between the inlet nozzle and the outlet nozzle;
an actuator disposed within the valve portion of the housing for positioning the flow tube with respect to the flow diverter in the outlet nozzle, the actuator comprising:
an electrically active component;
an electric wire extending from the electrically active component to the electronics portion of the housing; and
a seal assembly connected to the electrically active component, the seal assembly comprising:
a plug inserted into an opening in the electrically active component;
an outer groove circumscribing the plug;
a seal disposed in the outer groove between the plug and the electrically active component;
an interior passage through which the electric wire extends; and
a seal disposed within the interior passage between the plug and the electric wire.
